(19) United States
(12) Patent Application Publication
(10) Pub. No.: US 2008/0115060 A1
(43) Pub. Date: May 15, 2008

(54) Computer user interface menu selection process

(75) Inventor: Sean Mosko, Taipei (TW)

Correspondence Address: BACON & THOMAS, PLLC, 625 SLATERS LANE, FOURTH FLOOR, ALEXANDRIA, VA, 22314, US

(73) Assignee: FIRST INTERNATIONAL COMPUTER, INC., Taipei (TW)

(21) Appl. No.: 11/599,375

(22) Filed: Nov. 15, 2006

(51) Int. Cl. G06F 17/00; G06F 3/00

(52) U.S. Cl. 715/702

(57) ABSTRACT

A computer user interface menu selection process for allowing a user to use a finger, a pen or a stylus to manipulate a menu. The menu on a touch screen comprises multiple actuating zones which can be selected by the user. These multiple actuating zones are separated by multiple curve lines.

### BACKGROUND OF THE INVENTION

1. Field of the Invention

The present invention relates to a user interface menu shown on a touch screen of a computer based menu system, such as a cell phone, a PDA phone, a PDA and an Ultra Mobile PC (UMPC).

2. Description of the Related Art

Menus are traditionally displayed either in a “List Form” (FIG. 1) or an “Icon Form” (FIG. 2). These menus are suitable when used with a standard handheld keypad, as scrolling and selection can be done efficiently. But with a touch screen device this is more difficult because the contact areas are quite small.

It is therefore desirable to provide a more suitable menu design to mitigate and/or obviate the aforementioned problems.

### SUMMARY OF THE INVENTION

An objective of the present invention is to provide a menu shown on a touch screen which can be easily used by a user.

Another objective of the present invention is to provide an interesting menu design.

To achieve these objectives, the menu on a touch screen comprises of multiple actuating zones which can be selected by the user. These multiple actuating zones are separated by multiple curve lines.

According to one embodiment, both two ending points of each curve line are located either on or close to two different edges of the touch screen. In addition, the bending directions of each curve line is the same or similar.

Another embodiment shows that the bending directions of each curve line are not all the same.

Another embodiment shows that two ending points of some curve lines are located on or close to the same edge of the touch screen

Other objectives, advantages, and novel features of the invention will become more apparent from the following detailed description when taken in conjunction with the accompanying drawings.

### BRIEF DESCRIPTION OF THE DRAWINGS

FIG. 1 shows a traditional list form menu.

FIG. 2 shows a traditional icon form menu.

FIG. 3 shows a front view and a functional block drawing of a computer based menu system, such as a cell phone.

FIG. 4 shows a flow chart of the present invention.

FIG. 5 shows a menu according to a first embodiment of the present invention.

FIG. 6 shows an operation interface of the present invention.

FIG. 7 shows a menu according to a second embodiment of the present invention.

FIG. 8 shows a menu according to a third embodiment of the present invention.

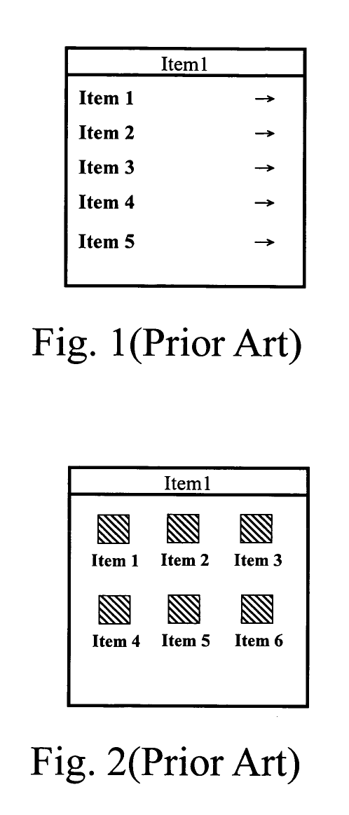

### ELEMENT DESCRIPTION

| | |
|---|---|
| cell phone 10 | processor 11 |
| memory 12 | touch screen 13 |
| input device 14 | microphone 15 |
| speaker 16 | wireless communication module 17 |
| phone book 20 | phone owner 21 |
| built phone number 22~24 | address 25 |
| menu 50a | actuating zone 61~66 |
| curve line 71~75, 31~36, 41~45 | operation interface 80 |

### DETAILED DESCRIPTION OF THE PREFERRED EMBODIMENT

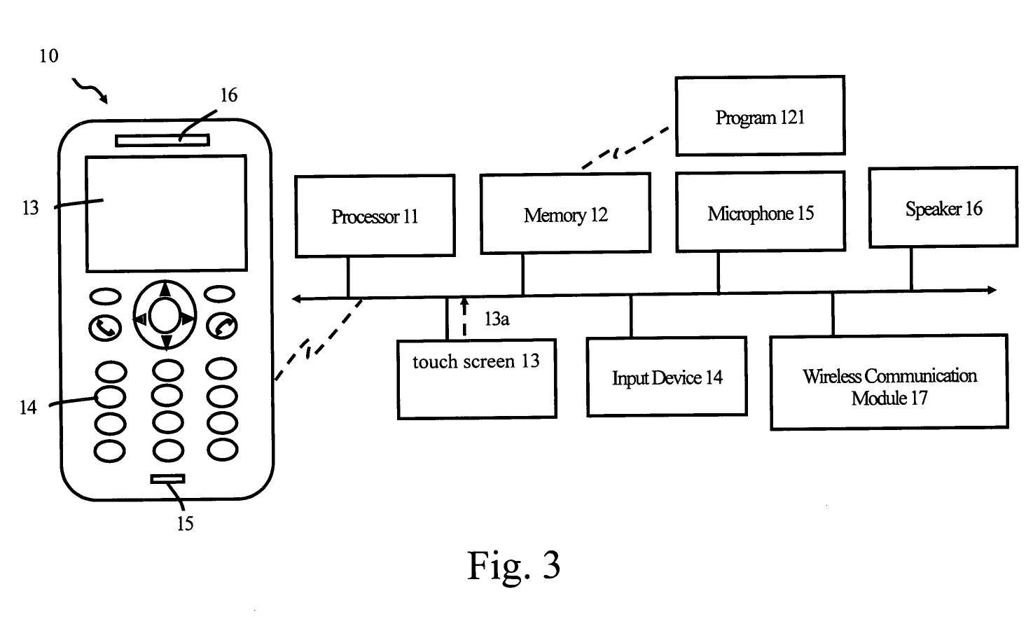

Please refer to FIG. 3. A computer based menu system, such as a cell phone 10 comprises a processor 11, a memory 12, a touch screen 13, an input device 14 (e.g. buttons), a microphone 15, a speaker 16 and a wireless communication module 17. The memory 12 (e.g. RAM, ROM, SDRAM, Memory Disk) has a software program 121 to be executed by the processor 11 to manage the operation or achieve certain functions. Because the mechanism and the circuit structure of the cell phone 10 is well known to those of reasonable skill in the art, the detailed description is omitted.

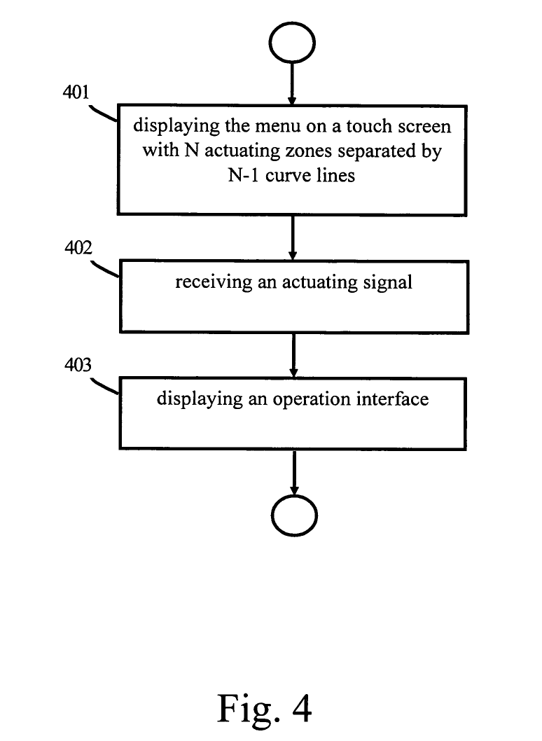

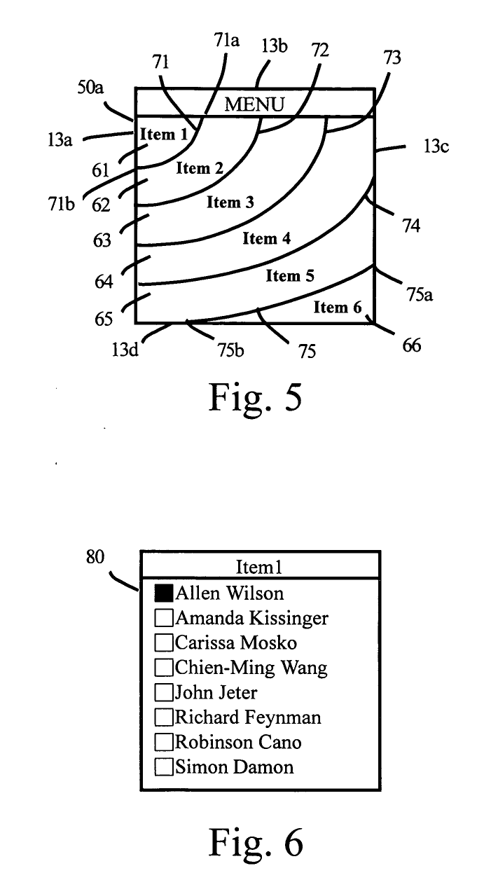

Please refer to FIG. 4 regarding the flow chart of the present invention, and also refer to FIG. 5 and FIG. 6 in conjunction with FIG. 4 for understanding the subject matter of the present invention.

### Step 401:

Displaying a menu 50a on the touch screen 13:

FIG. 5 shows the menu 50a according to a first embodiment. The menu 50a comprises of six actuating zones 61˜66, noted as item 1˜item 6, which can be selected by the user. Since the menu 50a is designed to be touched, a user usually uses a finger, a pen or a stylus to manipulate the menu 50a. Item 1˜item 6 represent the function of actuating zones, such as “calendar”, “phone book”, “setup”, “message” and etc.

The six actuating zones 61˜66 are separated by 5 curve lines 71˜75. According to the first embodiment, each curve line 71˜75 has two ending points which are located on or close to two different edges of touch screen 13 which has four display edges 13a, 13b, 13c, 13d. For example, the curve line 71 has two ending points 71a, 71b. The ending point 71a close to the display edge 13b and the ending point 71b located on display edge 13a. The curve line 75 has two ending points 75a, 75b. The ending point 75a located on the display edge 13c and the ending point 75b located on display edge 13d.

The mathematical relationship for the number of actuating zones and curve lines can be expressed as follows:

“N actuating zones are separated by N−1 curve lines”

Because the present invention prefers the small size touch screen 13, N is suggested to be less than or equal to 12. For the practical purpose, N is suggested to be larger than or equal to 3.

### Step 402:

Receiving an actuating signal according to user's selection from one of the actuating zones:

For example, the user uses his/her finger to touch the actuating zone 61. The hardware and software of the cell phone 10 will detect an actuating movement, and generates a specific actuating signal 13a (please refer to FIG. 3) according to which actuating zone is being touched, and then the software program 121 of the cell phone 10 will conduct the next action according to the specific actuating signal. The next action in the embodiment is Step 403.

Because the technique mentioned in step 402 is well known to those of reasonable skill in the art, the detailed description is omitted.

### Step 403:

In response to the actuating signal, an operation interface will be displayed on the touch screen 13.

Assume that the actuating zone 61 (item 1) regards to a “phone book”, FIG. 6 shows an operation interface 80 (e.g. “phone book”) on the touch screen 13. Since the hierarchical menu is very popular, the operation interface 80 can also be another “menu”. For example, the menu 50a is the first level menu, and each item of the menu 50a will lead to a corresponding second level menu. Therefore, the operation interface can either be a “non-menu” operation interface or a “menu” operation interface.

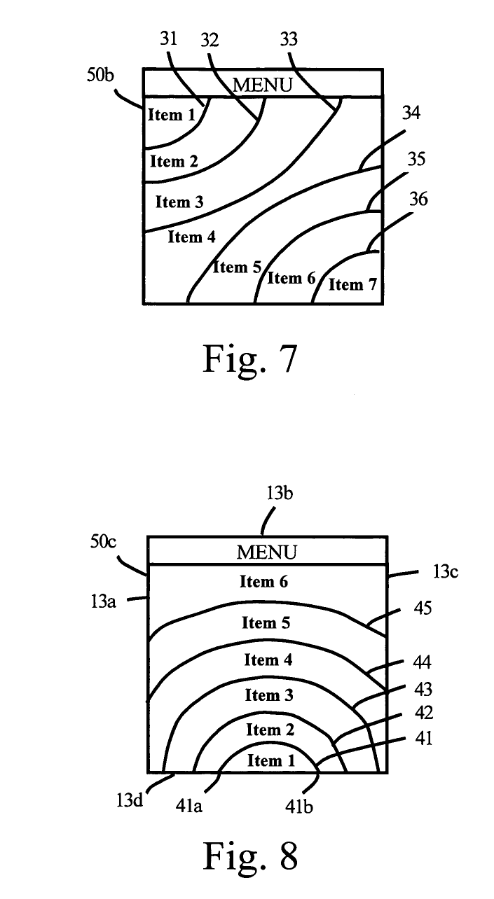

FIG. 7 shows a menu 50b according to a second embodiment of the present invention. The bending direction of the curve lines 31˜36 are not in the same direction. The curve lines 31˜33 tend to bend toward the top-left corner, and the curve lines 34˜36 tend to bend toward the bottom-right corner. However, the curve lines 71˜75 shown in FIG. 5 tend to bend toward the top-left corner.

FIG. 8 shows a menu 50c according to a third embodiment of the present invention. Unlike the curve lines 71˜75 shown in FIG. 5, the two ending points of the curve lines 41˜45 are not all located on or close to the two different display edges of the touch screen 13. For example, two ending points 41a, 41b of the curve line 41 are both located on the display edge 13d.

Although the present invention has been explained in relation to its preferred embodiment, it is to be understood that many other possible modifications and variations can be made without departing from the spirit and scope of the invention as hereinafter claimed.

What is claimed is:

1. A computer user interface menu selection process for allowing a user to use a finger, a pen or a stylus to manipulate a menu, comprising the steps of:
a) displaying the menu on a touch screen, wherein the menu comprises N actuating zones which can be selected by the user, and the N actuating zones are separated by N−1 curve lines, wherein 3≦N≦12;
b) receiving an actuating signal due to the user's selection from one of actuating zones;
c) in response to the actuating signal, displaying an operation interface onto the touch screen.

2. The computer user interface menu selection process as claimed in claim 1, wherein the touch screen has four display edges, and each curve line has two ending points located either on or close to the two different edges of the touch screen.

3. The computer user interface menu selection process as claimed in claim 2, wherein the two ending points of at least two curve lines is located on two adjacent edges of the display.

4. The computer user interface menu selection process as claimed in claim 1, wherein all of the curve lines have the same or similar bending direction.

5. The computer user interface menu selection process as claimed in claim 2, wherein all of the curve lines have the same or similar bending direction.

6. The computer user interface menu selection process as claimed in claim 3, wherein all of the curve lines have the same bending direction.

7. The computer user interface menu selection process as claimed in claim 1, wherein the touch screen is a cellular phone's touch screen.

8. The computer user interface menu selection process as claimed in claim 3, wherein the touch screen is a cellular phone's touch screen.

9. The computer user interface menu selection process as claimed in claim 5, wherein the touch screen is a cellular phone's touch screen.

10. The computer user interface menu selection process as claimed in claim 6, wherein the touch screen is a cellular phone's touch screen.

11. A computer based menu system comprising a processor 11, a memory 12 and a touch screen 13, the memory 12 comprising a computer program to be executed by the processor 11 to display a menu for allowing a user to use a finger, a pen or a stylus to manipulate the menu, characterized in that the menu comprising N actuating zones which can be selected by the user, and the N actuating zones are separated by N−1 curve lines, wherein 3≦N≦12.

12. The computer based menu system as claimed in claim 11, wherein the touch screen has four display edges, and each curve line has two ending points located either on or close to the two different edges of the touch screen.

13. The computer based menu system as claimed in claim 12, wherein the two ending points of at least two curve lines are located on the two adjacent display edges.

14. The computer based menu system as claimed in claim 11, wherein all of the curve lines have the same or similar bending direction.

15. The computer based menu system as claimed in claim 12, wherein all of the curve lines have the same or similar bending direction.

16. The computer based menu system as claimed in claim 13, wherein all of the curve lines have the same bending direction.

17. The computer based menu system as claimed in claim 11, wherein the touch screen is a cellular phone's touch screen.

18. The computer based menu system as claimed in claim 13, wherein the touch screen is a cellular phone's touch screen.

19. The computer based menu system as claimed in claim 15, wherein the touch screen is a cellular phone's touch screen.

20. The computer based menu system as claimed in claim 16, wherein the touch screen is a cellular phone's touch screen.
